(19) United States
(12) Patent Application Publication
(10) Pub. No.: US 2003/0072645 A1
(43) Pub. Date: Apr. 17, 2003

(54) Edge gripping pre-aligner

(76) Inventors: Terry Murray, Winchester, MA (US); Preston Whitcomb, Hull, MA (US)

Correspondence Address: FISH & RICHARDSON PC, 225 FRANKLIN ST, BOSTON, MA, 02110, US

(21) Appl. No.: 10/216,083

(22) Filed: Aug. 9, 2002

Related U.S. Application Data
(60) Provisional application No. 60/311,290, filed on Aug. 9, 2001.

(51) Int. Cl. B25J 1/00

(52) U.S. Cl. 414/754

(57) ABSTRACT

An apparatus for holding and orienting a wafer includes a movable robot arm, and an end effector attached to an end of the robot arm, the end effector including a gripping mechanism which during operation holds and rotates the wafer about an axis that is perpendicular to the plane of the wafer, wherein the gripping mechanism comprises a first contacting member, and a second contacting member, and a drive member arranged to grip opposing edges of the wafer, and wherein the drive member comprises a first pair of rollers.

### CLAIM OF PRIORITY

This application claims priority under 35 USC §119(e) to U.S. Patent Application Serial No. 60/311,290, filed on Aug. 9, 2001, the entire contents of which are hereby incorporated by reference.

### INCORPORATION BY REFERENCE

This application herein incorporates by reference U.S. application Ser. No. 09/609,342, which was filed on Jul. 5, 2000.

### TECHNICAL FIELD

This application relates to end effectors for robotic handlers such as might be used in materials processing, e.g., semiconductor wafer processing.

### BACKGROUND

Robotic-handlers are commonly used to move materials, e.g. semiconductor wafers, between different stages of a wafer fabrication process. For example, robotic handlers might be used to move the wafer from a plasma etch station in a cluster tool to a deposition station or from a manufacturing station to a testing station. At some stages of the manufacturing process, the wafer that is delivered by the robotic handler must be in a known orientation. For example, if the stage involves a masking process, the orientation of the wafer is critical since the mask must be aligned with the previously formed patterns on the wafer. To achieve the proper alignment, the robotic handler typically moves the wafer to something referred to as a pre-aligning station. After the wafer is deposited at this station, the pre-aligner positions the wafer and rotates it to a predetermined orientation. Then, the robotic handler picks up the oriented wafer and moves it to the next processing stage.

A typical robotic handler includes an end effector and a robotic arm. The end effector is the part of the robotic handler that holds the wafer. The arm includes the mechanical mechanisms that are used to move the end effector and the wafer which it holds to the desired location.

### SUMMARY

In general, in one aspect, the invention is an apparatus for holding and orienting a wafer having an alignment feature. The apparatus includes a movable robot arm, and an end effector attached to an end of the robot arm, the end effector including a gripping mechanism which during operation holds and rotates the wafer about an axis that is perpendicular to the plane of the wafer, wherein the gripping mechanism include a first contacting member, and a second contacting member, and a drive member arranged to grip opposing edges of the wafer, and wherein the drive member include a first pair of rollers.

Other embodiments of the invention include one or more of the following features. The apparatus, wherein at least one of the first contacting member and the second contacting member include a second pair of rollers. The apparatus, wherein each roller of the roller pairs has a cylindrically-shaped outer surface and are arrayed in a common plane and have parallel axes of rotation. The apparatus, wherein the gripping mechanism include mechanical means coupled to move the drive member towards and away from the second and third contact members in response to a control signal. The apparatus, wherein the gripping mechanism further include a drive motor coupled to rotate at least one of the rollers of the first roller pair. The apparatus, wherein the gripping mechanism further include a drive roller chamber substantially surrounding at least one of the rollers of the first roller pair, and wherein the drive roller chamber is substantially sealed hermetically from the connection to the drive motor. The apparatus further includes a vacuum source coupled to the drive roller chamber to draw air from the drive roller chamber and towards the vacuum source during operation. The apparatus, wherein the gripping mechanism further include a gear chamber substantially surrounding the coupling to the drive motor, and wherein the gear chamber is substantially sealed hermetically from the first pair of rollers. The apparatus includes a vacuum source coupled to the gear chamber to draw air from the gear chamber towards the vacuum source during operation. The apparatus includes a frame, the second contacting member and the third contacting member attached to an outer end of the frame, a wheel chamber substantially surrounding at least one of the second and third contacting members, wherein the frame includes an airflow channel formed into the frame and proximate to the wheel chamber. The apparatus, wherein the airflow channel include a groove formed into a surface of the frame, the apparatus further includes a groove cover coupled to the frame and covering the groove to form the airflow channel. The apparatus further includes a vacuum source coupled to the airflow channel to draw air from the wheel chamber during operation. The apparatus, wherein an outer surface of at least one of the rollers has a circumferential v-shaped groove formed therein and is substantially comprised of a polyethyletherkeytone (PEEK) material. The apparatus, wherein the v-groove includes a polished groove having surface irregularities no greater than sixty-four micro-inches in depth. The apparatus, wherein, during operation of the apparatus, a loading pressure applied by the drive rollers perpendicular to the plane of the wafer is in the range of one to three pounds. The apparatus of claim 2, wherein the speed of rotation of the wafer is less than or equal to two revolutions per second during operation.

In another aspect, the invention is a method of holding and orienting a wafer. The method includes moving an end effector using a robot arm, gripping a wafer using the end effector, rotating the wafer about an axis that is perpendicular to the plane of the wafer, wherein gripping includes holding the wafer between a first contacting member, a second contacting member, and a pair of drive rollers arranged to grip opposing edges of the wafer, and wherein rotating include rotating at least one of the drive rollers against an edge of the wafer.

Other embodiments of the invention include one or more of the following features. The method, wherein the first contacting member include a first pair of rollers, the second contacting member include a second pair of rollers, and wherein gripping further include holding the wafer between the pairs of drive rollers the second pair of rollers and the third pair of rollers. The method, wherein gripping further include gripping the wafer between the drive rollers and the second pair and third pair of rollers, the rollers include cylindrically-shaped outer surfaces and are arrayed in a common plane and have parallel axes of rotation. The method, wherein gripping further include moving the drive member towards and away from the second and third contact members in response to a control signal. The method, wherein rotating further include rotating the at least one of the drive rollers using a drive motor coupled to the at least one of the rollers. The method, further includes drawing air from a drive roller chamber substantially surrounding at least one of the drive rollers, wherein the drive roller chamber is substantially sealed hermetically from the coupling to the drive motor. The method, further includes drawing air from a gear chamber substantially surrounding the coupling to the drive motor, wherein the gear chamber is substantially sealed hermetically from the drive rollers. The method, further includes drawing air from a chamber substantially surrounding at least one of the second and third contacting members. The method, wherein an outer surface of at least one of the rollers has a circumferential v-shaped groove formed therein and is substantially comprised of a polyethyletherkeytone (PEEK) material. The method, wherein the v-groove include a polished groove having surface irregularities no greater than sixty-four micro-inches in depth. The method, further includes applying a loading pressure by at least one of the drive rollers perpendicular to the plane of the wafer in the range of one to three pounds. The method, wherein rotating further includes rotating the wafer using a speed of rotation of the wafer less than or equal to two revolutions per second.

In another aspect, the invention is an apparatus for illuminating and imaging a surface of a wafer. The apparatus includes a light source, a diffuser element to receive light from the light source and transmit a diffused light, a beam splitter to receive the diffused light and split the diffused light, a reflective element to receive the split diffused light from the beam splitter and reflect the diffused light onto the surface of the wafer, and to receive a reflected light from the wafer surface, and a camera to receive and image the reflected light from the wafer, wherein the reflective element is mounted above or below the wafer and occupies a space of about ¼ inch or less above or below the wafer surface.

Other embodiments of the invention include one or more of the following features. The apparatus, wherein the diffuser element comprises a frosted glass. The apparatus, wherein the reflective element comprises a mirror. The apparatus, wherein the light source comprises an array of light emitting diodes (LEDs). The apparatus may further include a second reflective element, wherein the first reflective element and second reflective element are mounted on opposite sides of the wafer, and the diffused light is transmitted from the light source to the first and second reflective elements onto the opposite sides of the wafer, wherein the reflected light is received by the camera from both sides of the wafer and includes an image from both sides of the wafer. The apparatus, wherein the reflective elements comprise mirrors, and both the first and second mirrors are mounted within a space of about ¼ inch or less above or below the wafer surface. The apparatus may further include a movable robot arm, and an end effector attached to an end of the robot arm, said end effector including a gripping mechanism which during operation holds and rotates the wafer about an axis that is perpendicular to the plane of the wafer. The apparatus, wherein the gripping mechanism comprises a first contacting member, and a second contacting member, and a drive member arranged to grip opposing edges of the wafer, and wherein the drive member comprises a first pair of rollers. The apparatus, wherein at least one of the first contacting member and the second contacting member comprises a second pair of rollers. The apparatus, wherein the gripping mechanism comprises mechanical means coupled to move the drive member towards and away from the second and third contact members in response to a control signal.

The invention may have one or more of the following advantages. An end effector using closely-spaced roller pairs to support the wafer edge may reduce the potential skip and noise caused by the detent of the alignment notch rotating past a roller. Chambers surrounding the driving gears, driving rollers and the idler rollers may be used to isolate particles generated while rotating a wafer. A vacuum source may be connected to the chambers to-draw any particles generated away from a clean room environment of a fabrication facility. Specific materials and geometries of the rollers are described that may reduce the generation of particles and may reduce noise during operation of the end effector.

### DESCRIPTION OF DRAWINGS

FIG. 1 shows a top view of a pre-aligner in an “open” position;

FIG. 2 shows a top view of the pre-aligner of FIG. 1 holding a wafer in a “closed” position;

FIG. 3 shows a horizontal cross section of the drive housing shown in FIGS. 1 and 2;

FIG. 4 shows a vertical cross section of the drive housing and guide roller housing shown in FIGS. 1 and 2;

FIG. 5 shows a vertical cross section of an alternate embodiment of the guide roller housing;

FIG. 6 shows the details of the sensor of FIGS. 1 and 2;

FIG. 7 shows a wafer rack for holding the wafer of FIGS. 1 and 2;

FIG. 8 shows a first embodiment of an illumination and imaging system;

FIG. 9 shows an combined image corresponding obtained using the system of FIG. 8;

FIG. 10 shows a second embodiment of an illumination and imaging system;

FIG. 11 shows a third embodiment of an illumination and imaging system.

Like reference symbols in the various drawings indicate like elements.

### DETAILED DESCRIPTION

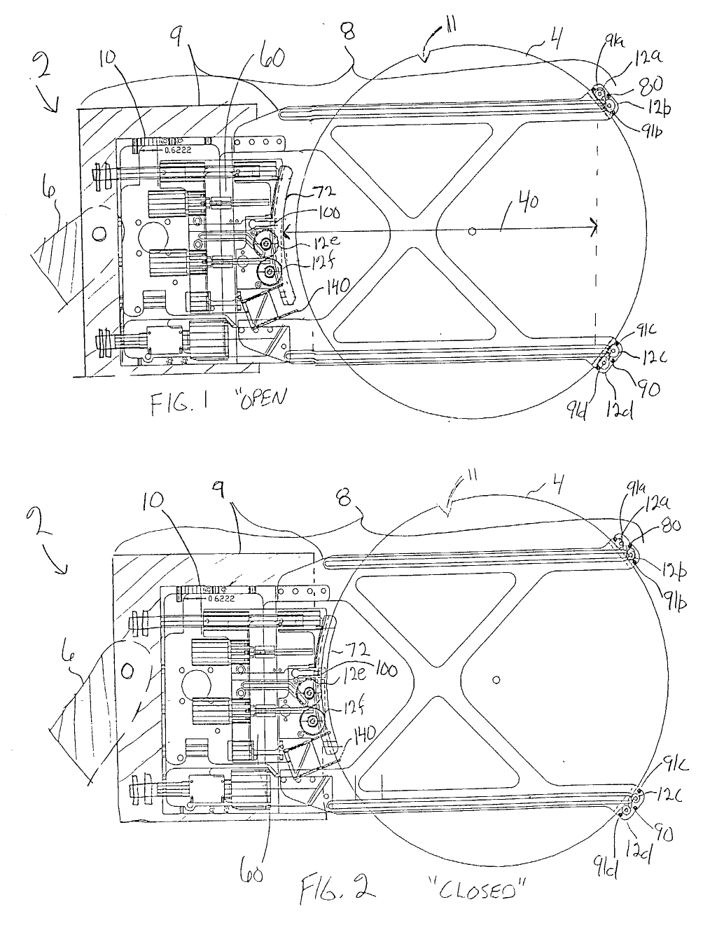

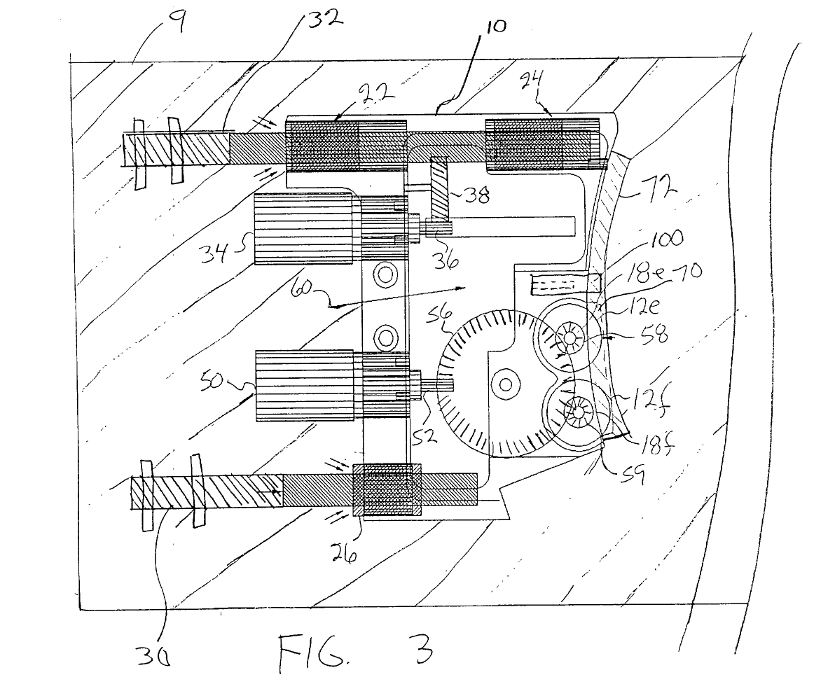

Referring to FIGS. 1-2, a robotic handler 2 for moving a wafer 4 has two primary components, namely, a robotic arm 6 and an end effector 8 attached to one end of robotic arm 6. End effector 8 is used to grab, hold and orient a wafer 4. Robotic arm 6, which includes various motors and mechanical mechanisms not shown in the figures, moves end effector 8 and the wafer that it holds within its grasp.

Wafer 4 is typically a circular disk of semiconductor material, e.g. silicon. It generally is of uniform thickness and has an alignment feature 11 at one location on its circumference. Alignment feature 11 is typically a v-shaped notch, as depicted in FIGS. 1-2. The alignment feature serves as a reference that can be used to align the wafer to a known orientation. As will be described in greater detail below, end effector 8 includes a frame 9 attached to robotic arm 6 and a movable drive housing 10 for grasping and rotating wafer 4 as it is being held by the end effector. The end effector also includes sensor circuitry 100 for detecting the alignment feature and thereby determining and establishing the orientation of wafer 4.

In the described embodiment, the gripping mechanism includes two pairs of idler rollers 12a-b and 12c-d mounted at the remote ends of a support frame 9, and a pair of drive rollers 12e-f mounted in a drive housing 10. All of the rollers 12a-12f are arrayed in a common plane having parallel axes of rotation.

Referring to FIGS. 1-3, drive housing 10 includes bearings 22 and 24, and bearing 26, that slide over shafts 30 and 32, respectively. Shafts 30 and 32 are connected at one end to frame 9. Drive housing 10 also includes a linear drive motor 34 that has a splined drive shaft 36 extending into a gear chamber 60. Splined shaft 36 is connected to mesh with a gear 38 that is connected to mesh with linear shaft 32. Thus, in response to a control signal, the rotational movement of drive shaft 36 causes housing 10 (and drive rollers 12e-f) to move towards, or away from, idler roller pairs 12a-b and 12c-d. When housing 10 is moved away from idler roller pairs 12a-b and 12c-d, a separation space 40 (see FIG. 1) becomes large enough to accept wafer 4 (separation space 40 is defined by the three rollers pairs 12a-b, 12c-d and 12e-f). Once wafer 4 is located within separation space 40, motor 34 is actuated to move housing 10 towards idler roller pairs 12a-b and 12c-d until all three pairs of rollers contact the outer periphery of and hold wafer 4 (see FIG. 2). Roller pairs 12a-b, 12c-d and 12e-f are positioned so that they contact the periphery of wafer 4 at locations which are separated sufficiently from each other so that that wafer readily slides into the grasp of the rollers and is held securely there.

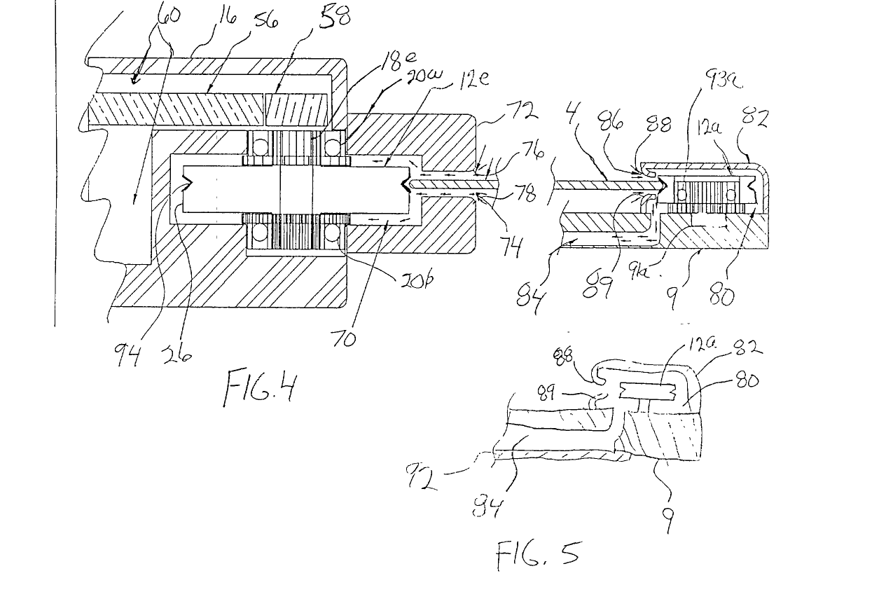

Referring to FIG. 4, a bearing 93a and shaft 91a supports idler roller 12a, so that roller 12a rotates freely. Idler rollers 12b-12d are supported similarly on corresponding bearings (not shown) and shafts 91b-91d, respectively.

Referring to FIGS. 3 and 4, each drive roller 12e and 12f is mounted on a rotating shaft 18e and 18f, respectively, that are supported by bearing pairs, mounted in housing 10. Bearing pair 20a and 20b, which support both ends of shaft 18e, respectively, is shown in greater detail in FIG. 4. A similar bearing pair (not shown) supports shaft 18f in drive housing 10, and is constructed similarly. The mechanism for rotating drive rollers 12e-f includes a rotational drive motor 50 mounted on drive housing 10. Drive motor 50 is a servo-controlled motor that has a splined drive shaft 52, which extends into gear chamber 60. Drive shaft 52 meshes with a large spur gear 56. Large spur gear 56 is connected to mesh with two smaller spur gears 58 and 59 that are connected to an upper end of rotating shafts 18e and 18f, respectively. Thus, when actuated, drive motor 50 causes both drive rollers 12e-f to rotate in the same direction and speed. And when drive rollers 12e-f are contacting the periphery of wafer 4, it causes wafer 4 to rotate within the grasp of the three roller pairs 12a-b, 12c-d and 12a-f.

Each individual roller within a roller pair 12a-b, 12c-d and 12e-f is mounted with a slight separation between its partner in the pair, for example roller 12a is mounted with a slight separation from roller 12b. Therefore, as the alignment notch 10 is rotated past a roller pair an un-notched section of the wafer edge is always fully in contact with one of the rollers in the roller pair. The use of closely-spaced roller pairs, rather than single rollers, to support the wafer edge reduces the potential skip and noise caused by the detent of the alignment notch rotating past each roller.

Still referring to FIG. 3, drive housing 10 is partitioned into two particle containment chambers, a gear chamber 60 and a drive roller chamber 70. Gear chamber 60 surrounds gears 56, 58 and 59, and motor shafts 36 and 52. And drive roller chamber 70 surrounds drive rollers 12e and 12f. A vacuum source (not shown) is connected to draw air from chambers 60 and 70, thereby removing particles that may be generated by the meshing of gears in gear chamber 60 and generated by the rotation of the wafer edge against drive rollers 12e-f in roller chamber 70, respectively.

Referring to FIGS. 3 and 4, roller chamber 70 includes a cover 72 attached to a side of drive housing 10 to more fully enclose drive rollers 12e and 12f. Cover 72 includes a longitudinal access slot 74 that extends end-to-end into a side of cover 72. Slot 74 allows wafer 4 to be inserted into roller chamber 70 and make contact with drive rollers 12e and 12f. Access slot 74 is beveled at edges 76 and 78 to guide a slightly mis-aligned wafer into slot 74.

Each of the idler roller pairs 12a-b and 12c-d are contained with idler roller chambers 80 and 90, respectively. The construction of idler roller chamber 80 is shown in greater detail in FIG. 4. Idler roller chamber 90 is constructed similarly. A cover 82 is attached to frame 9 and defines the upper section of chamber 80 surrounding rollers 12a and 12b. Cover 82 includes a longitudinal access slot 86 that extends end-to-end into a side surface of cover 82 and allows a wafer to be inserted into chamber 80 and make contact with idler rollers 12a and 12b. Slot 86 is beveled at edges 88 and 89 to guide a slightly mis-aligned wafer into slot 86. An airflow channel 84 is formed into frame 9 with an end of channel 84 directly below and into chamber 80. A vacuum source (not shown) connected to the airflow channel draws air into chamber 80 and draws any particles away from idler roller chamber 80.

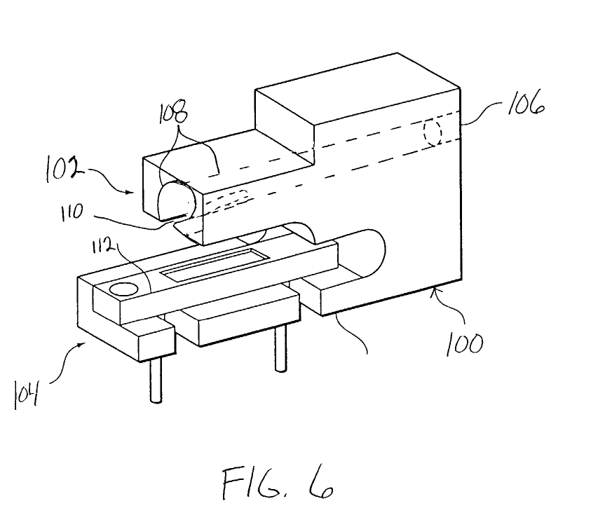

In one embodiment, airflow channel 84 is formed internally within frame 9, as shown in FIG. 4. Alternatively, as shown in FIG. 5, airflow channel 84 is formed into a surface of frame 9 and covered with a channel cover 92 to direct an airflow through channel 84.

Typically, end effector 8 is housed in a clean room environment with highly filtered air surrounding end effector 8. Therefore, a vacuum source (not shown) connected to draw air from chambers 60, 70, 80 and 90 causes a flow of filtered air from the clean room into the respective chambers and draws any particles away from the clean room environment.

The geometry of drive roller 12e is shown in greater detail in FIG. 4. The other rollers 12a-d and 12f are constructed similarly. Roller 12e has a substantially cylindrical outer rim 26, which includes a v-shaped positioning groove 94 formed around its outer circumference. When the rim of the roller is brought into contact with the periphery of the wafer, positioning groove 94 receives and holds the edge of the wafer thereby preventing the wafer from sliding either up or down on the roller. Since all six rollers 12a-f have a similar positioning groove, when the rollers are contacting the periphery of the wafer and the wafer sits in the corresponding positioning grooves of the six rollers, the plane of the wafer is fixed and precisely determined.

To reduce the generation of particles and noise while spinning a wafer, the outer surfaces of rollers 12a-f are made from a polyethyletherkeytone-filled (PEEK-filled) material. For similar reasons, in an embodiment, v-groove 94 has a polished finish with pits and valleys that measure sixty-four micro-inches or less. For similar reasons, in an embodiment, the maximum speed of wafer rotation is less than, or equal to, two revolutions per second, and the side load pressure applied against the wafer edge by the roller pairs is in the range of one to three pounds.

Referring to FIGS. 3 and 6, end effector 8 has an optical sensing system 100 for detecting the presence of the alignment feature 11 on wafer 4 as it passes by while the wafer is being rotated. Examples of sensing system 100 are described in the '342 application, which was previously incorporated by reference. Sensing system 100 has an upper arm 102 that contains the light emitting components and a lower arm 104 that contains the light detecting components. When the wafer is being held by rollers 12a-12f, the edge of the wafer lies between upper and lower arms 102 and 104. Upper arm 102 includes a light source 106 (shown in phantom) that is used to illuminate the edge of the wafer (light source 106 may be implemented, for example, as a diode, a fiber optic or a bulb). The light from light source 106 passes through a cylindrical tube 108 that acts as a collimator to guide the light from light source 106. Tube 108 includes an aperture opening 110 that directs the light down through aperture 110 toward the wafer. Aperture 110 is narrow and long, with its longer dimension oriented perpendicular to the edge of the wafer. Lower arm 104 includes a silicon diode receiver 112 which has a detecting window that is also long and narrow, and is aligned with the aperture of the tube 108. The signal generated by diode receiver 112 is proportional to the amount of light from aperture 110 that reaches it.

When wafer 4 is rotated within the grasp of end effector 8, the edge of the wafer passes between the light emitting and light detecting components. Optical housing 100 is positioned so that the edge of the wafer prevents some of the light from tube 108 from reaching diode receiver 112. When the alignment feature passes between the light emitting and light detecting components, more light is allowed to reach diode receiver 112 and its output signal increases. And as the alignment feature moves past the sensor, the signal decreases to its previous value. Thus, by monitoring the output signal of the diode receiver, the electronics can detect the presence of the alignment feature, can determine its precise angular location as a function of the rotational position of the wafer, and can precisely align the angular orientation of the wafer.

In an embodiment of sensing system 100, the interior walls of tube 108 are coated with a diffusing material, e.g., a white paint. The diffusing coating on the interior surface causes the light passing through the tube to be diffused and reflected and may increase the amount of light passing through aperture 110. In another embodiment, the end of tube 108, opposite from the light source 106, is capped (not shown) with a cap having an interior surface coated with a diffusing material, e.g., a white paint. The cap's diffusing interior coating causes the light passing through the tube to be diffused and may increase the amount of light, or intensity of the light, passing through aperture 110. In either of these two embodiments, an increase in the amount or intensity of the light emitted from aperture 110 may reduce the required sensitivity of receiver 112, or may reduce the amount or intensity required from light source 106.

The techniques for determining the angular location of the alignment feature and then aligning the wafer based on that information are well known to persons skilled in the art. Such techniques are typically used in connection with standalone pre-aligners of the type briefly mentioned earlier. An example of one such technique that can be used is described in U.S. Pat. No. 4,457,664, entitled “Wafer Alignment Station” and incorporated herein by reference.

End effector 8 is coupled to a processor (not shown) which implements the electrical control functions that are necessary. For example, it generates the control signals for the drive motor and the linear motor, and it analyzes the sensing signal to determine and establish the orientation of the alignment feature of the wafer.

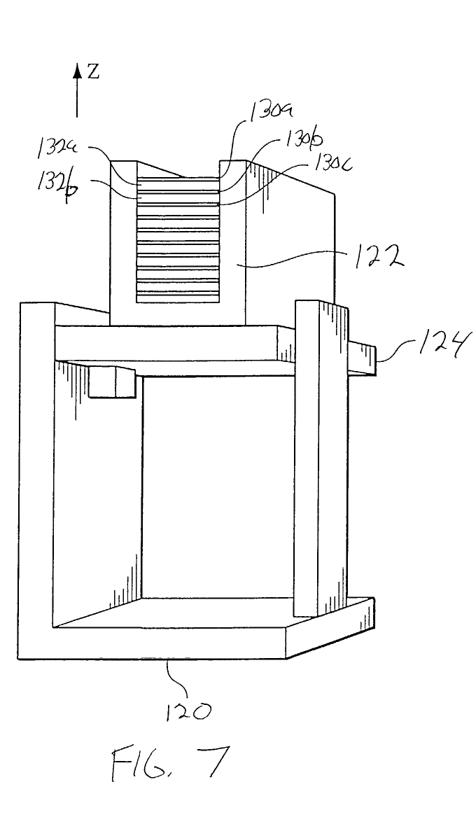

Referring to FIG. 7, a typical use of the end effector is to grab wafers from a wafer storage rack 120 and then transfer them to a masking station (not shown). Generally, rack 120 has a wafer holder 122 mounted on a platform 124 that can be displaced in a direction z. The wafer holder holds wafers 130a-c, which are spaced apart by spaces 132a, 132b.

There are numerous illumination and imaging (“I/I”) schemes in the prior art that are usable for the reading of markings on a surface of a wafer, e.g., Optical Character Recognition (OCR) markings, Dot-t7 codes, bar codes, and the like. For example, U.S. Pat. Nos. 5,231,536, 5,737,122 and 5,822,053 describe I/I schemes. A conventional I/I system includes an illumination component that shines light onto a wafer, for example, and a camera system that captures a reflected image of the OCR, bar code, or dot-t7 code from the wafer surface. Typically, the I/I systems project light from various selectable angles onto the smooth, mirror-like wafer surface. The relative angles of incidence of this illumination is sometimes very close to on-axis and is called bright field illumination, or at steep angles and is called dark field illumination. Typically, the information being imaged by the camera is not the relatively shiny surface of the wafer, but instead, what is imaged are the micro pits of the markings that have been etched into the wafer surface, that is, it is the slope of these pits that is actually imaged.

Conventional I/I system typically require a fairly large amount of space to hold the various components in the system, e.g., using a package that may measure 3″ wide, 2″ high and 5″ long. The relatively large size of the conventional I/I system may not be easily adapted to operate as part of applicants' edge effector, since it would occupy too much room on the pre-aligner and hinder the movement and access of the pre-aligner to close-fitting spaces for wafer pickup and deposit. Moreover, the use of a conventional I/I system typically requires a separate station apart from the pre-aligner station, which would, therefore, require additional time to perform that step in the process of wafer fabrication.

In an embodiment, edge effector 8 includes a low-profile I/I system 140 (see FIGS. 1 and 2) that illuminates and images wafer surface markings as part of the pre-aligner 4. Described below are a number of embodiments of the low-profile I/I system that typically occupy about ¼″ of space above or below the wafer surface. An embodiment of the low-profile I/I system may be included as part of pre-aligner 4, therefore the pre-aligner may be used to perform the grabbing, orienting and imaging of a wafer in a single pre-aligner station.

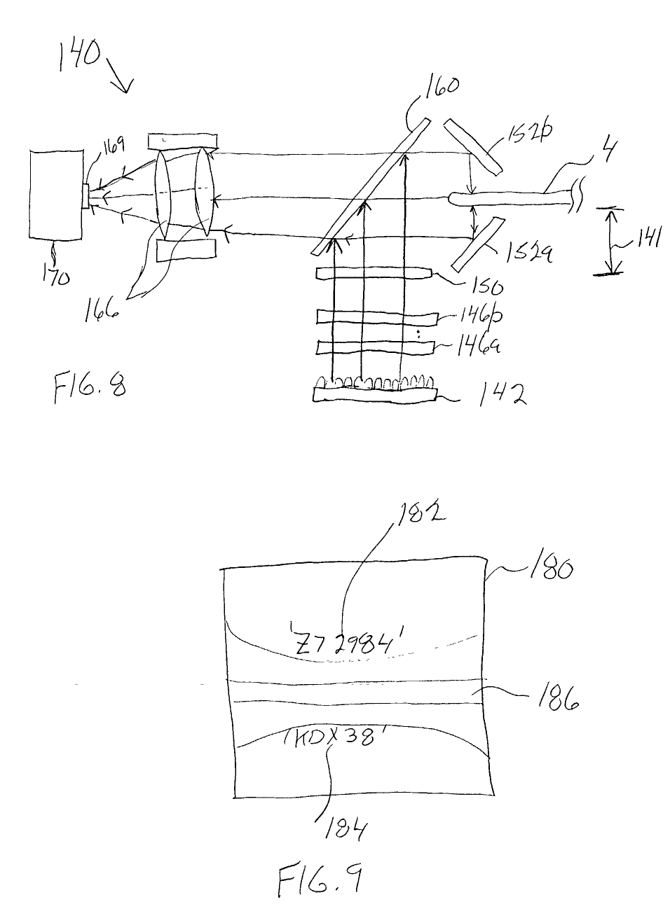

Referring to FIG. 8, a first embodiment of a low-profile I/I system 140 is shown. I/I system 140 includes a light source that emits light that is diffused by one or more diffusing elements and reflected by a reflective element (e.g., a mirror) onto a surface of a wafer. The diffused light from the wafer surface is reflected and detected by a camera as an image that may be used to determine the markings on the wafer surface. In the described embodiments of I/I system, the diffused light is produced by passing light beams through a diffusing element (e.g., a frosted glass element and/or a diffuser element). The diffused light source (e.g., the frosted glass element and/or diffuser element) is located adjacent to the wafer being illuminated, therefore the distance the diffused light must travel to illuminate the wafer surface is reduced. The relatively close proximity of the diffused light source to the wafer surface may reduce the required amount and/or intensity of the light from the light source. Therefore a smaller light source may be used and the size of other components included in a low-profile I/I system may also be reduced.

Still referring to FIG. 8, in this embodiment, system 140 includes an LED array 142 that acts as a light source. During operation, LED array 142 is turned on to shine light beams through a set of diffusers 146a-b, and a frosted glass 150 towards a beam-splitter 160. The diffused light beams are partially reflected by a beam-splitter 160 towards two mirrors, 152a and 152b, that are mounted above and below a wafer 4, respectively. Mirrors 152a and 152b reflect the diffused light towards the edge of the upper and lower surfaces of wafer 4, respectively. The diffused light reflects off of the upper and lower surfaces of wafer 4, and in turn, is reflected back by mirrors 152a and 152b towards beam-splitter 160. Beam-splitter 160 passes part of the reflected light towards lenses 166, which focuses the reflected light onto a charge-coupled detector (CCD) array 169 of camera 170. The reflected light received on CCD array is usable as an image to determine the markings on the edge surfaces of wafer 4. Referring to FIG. 9, the two mirrors, 152a and 152b, are arranged to reflect the light from both the upper and lower surfaces of wafer 4, so that an image 180 is obtained that includes an image of the upper surface 182, the wafer edge 186 and the lower surface 184. In an embodiment, I-I system 140 includes mirrors 152a and 152b that are each located about ¼″ above and ¼″ below wafer 4, respectively. The overall package size containing the other components of system 140 may be relatively larger.

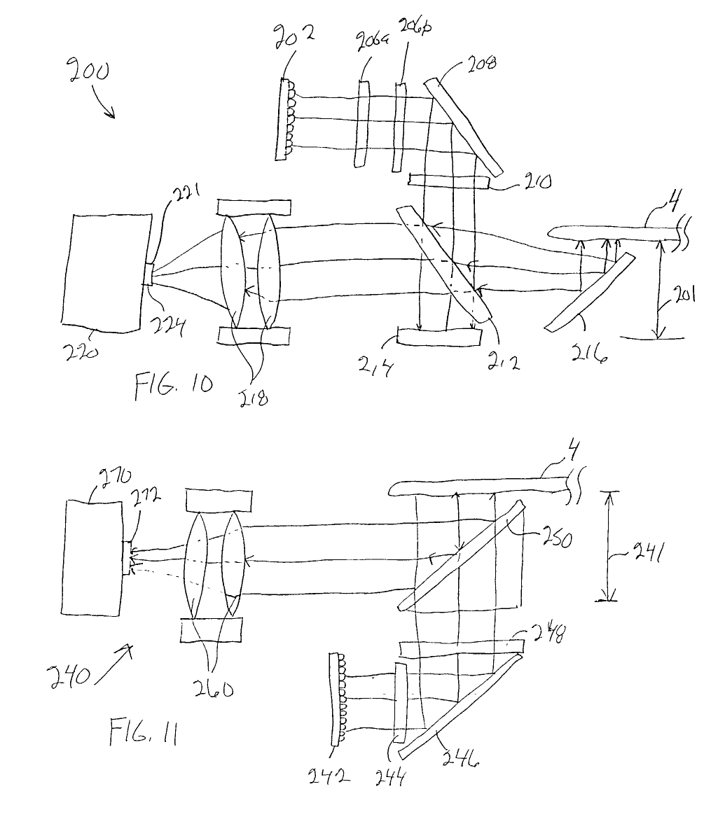

Referring to FIG. 10, a second embodiment of a low-profile I/I system is shown as system 200. System 200 includes a LED array 202 that shines light that is first diffused by one or more diffusers 206a and 206b. The diffused light is reflected by mirror 208 and further diffused by passing through frosted glass 210. The further diffused light is partially reflected by a beam-splitter 212 onto mirror 216 that reflects the further diffused light onto the lower surface of wafer 4. The further diffused light is reflected by wafer 4 onto mirror 216 and back through beam-splitter 212, through lenses 218 and onto CCD array 221 or camera 220. In this case only one surface of wafer 4 is illuminated and imaged. Also, in this embodiment, an absorber 214 is included to reduce back-reflections of light passing through beam-splitter 214.

Referring to FIG. 11, a third embodiment of low-profile I/I system is shown as system 240. System 240 includes only a single mirror, mirror 246. The use of fewer mirrors may reduce the amount of error included in a reflected image. System 140 includes a LED array 242 that shines light through a diffuser element 244, the diffused light is reflected on a mirror 246 and through a frosted glass 248. The diffused light that passes through frosted glass 248 is partially passed through beam-splitter 250 and onto the lower surface of wafer 4. The diffused light is reflected from the lower surface of wafer 4 back onto beam-splitter 250 which partially reflects the light towards lenses 260 which focus the light onto a CCD array 272 of camera 270.

Although the described embodiments of the I/I systems included multiple diffuser elements, a single diffuser element may be used.

In the described embodiments of the I/I systems an LED array was described as the light source. In an embodiment, individual rows of the LED array may be turned on or off to produce on-axis or off-axis illumination of the wafer surface.

A number of embodiments of the invention have been described. Nevertheless, it will be understood that various modifications may be made without departing from the spirit and scope of the invention. For example, more than three roller pairs may be used to grasp the periphery of the wafer and the transport mechanism for rotating the wafer. We also mentioned specific geometries and construction materials of the rollers used in the end effector. However, other roller materials and geometries could be used. We also mentioned opening and closing the gripping mechanism with a linear drive motor and associated gearing. However, other devices could be used to open and close the gripping mechanism, for example, a hydraulically operated device. Also, other kinds of sensors may be used to sense the orientation of the wafer. The sensors may detect the presence of the alignment feature by physical contact, magnetic fields, or capacitance, just to name a few possible ways. Accordingly, other embodiments are within the scope of the following claims.

What is claimed is:

1. An apparatus for holding and orienting a wafer, said apparatus comprising:
a movable robot arm; and
an end effector attached to an end of the robot arm, said end effector including a gripping mechanism which during operation holds and rotates the wafer about an axis that is perpendicular to the plane of the wafer,
wherein the gripping mechanism comprises a first contacting member, and a second contacting member, and a drive member arranged to grip opposing edges of the wafer, and
wherein the drive member comprises a first pair of rollers.

2. The apparatus of claim 1, wherein at least one of the first contacting member and the second contacting member comprises a second pair of rollers.

3. The apparatus of claim 2, wherein each roller of the roller pairs has a cylindrically-shaped outer surface and are arrayed in a common plane and have parallel axes of rotation.

4. The apparatus of claim 1, wherein the gripping mechanism comprises mechanical means coupled to move the drive member towards and away from the second and third contact members in response to a control signal.

5. The apparatus of claim 4, wherein the gripping mechanism further comprises a drive motor coupled to rotate at least one of the rollers of the first roller pair.

6. The apparatus of claim 5, wherein the gripping mechanism further comprises: a drive roller chamber substantially surrounding at least one of the rollers of the first roller pair,
wherein the drive roller chamber is substantially sealed hermetically from the connection to the drive motor.

7. The apparatus of claim 6, further comprising:
a vacuum source coupled to the drive roller chamber to draw air from the drive roller chamber and towards the vacuum source during operation.

8. The apparatus of claim 6, wherein the gripping mechanism further comprises a gear chamber substantially surrounding the coupling to the drive motor,
wherein the gear chamber is substantially sealed hermetically from the first pair of rollers.

9. The apparatus of claim 8 further comprising:
a vacuum source coupled to the gear chamber to draw air from the gear chamber towards the vacuum source during operation.

10. The apparatus of claim 2 further comprising:
a frame, the second contacting member and the third contacting member attached to an outer end of the frame,
a wheel chamber substantially surrounding at least one of the second and third contacting members,
wherein the frame includes an airflow channel formed into the frame and proximate to the wheel chamber.

11. The apparatus of claim 10, wherein the airflow channel comprises a groove formed into a surface of the frame, the apparatus further comprising:
a groove cover coupled to the frame and covering the groove to form the airflow channel.

12. The apparatus of claim 10 or 11 further comprising:
a vacuum source coupled to the airflow channel to draw air from the wheel chamber during operation.

13. The apparatus of claim 2, wherein an outer surface of at least one of the rollers has a circumferential v-shaped groove formed therein and is substantially comprised of a polyethyletherkeytone (PEEK) material.

14. The apparatus of claim 13, wherein the v-groove comprises a polished groove having surface irregularities no greater than sixty-four micro-inches in depth.

15. The apparatus of claim 2, wherein, during operation of the apparatus, a loading pressure applied by the drive rollers perpendicular to the plane of the wafer is in the range of one to three pounds.

16. The apparatus of claim 2, wherein the speed of rotation of the wafer is less than or equal to two revolutions per second during operation.

17. A method of holding and orienting a wafer, said method comprising:
moving an end effector using a robot arm;
gripping a wafer using the end effector;
rotating the wafer about an axis that is perpendicular to the plane of the wafer,
wherein gripping comprises holding the wafer between a first contacting member, a second contacting member, and a pair of drive rollers arranged to grip opposing edges of the wafer, and
wherein rotating comprises rotating at least one of the drive rollers against an edge of the wafer.

18. The method of claim 17, wherein the first contacting member comprises a first pair of rollers, the second contacting member comprises a second pair of rollers, and wherein gripping further comprises holding the wafer between the pairs of drive rollers the second pair of rollers and the third pair of rollers.

19. The method of claim 18, wherein gripping further comprises gripping the wafer between the drive rollers and the second pair and third pair of rollers, the rollers include cylindrically-shaped outer surfaces and are arrayed in a common plane and have parallel axes of rotation.

20. The method of claim 17, wherein gripping further comprises moving the drive member towards and away from the second and third contact members in response to a control signal.

21. The method of claim 20, wherein rotating further comprises rotating the at least one of the drive rollers using a drive motor coupled to the at least one of the rollers.

22. The method of claim 21, further comprising drawing air from a drive roller chamber substantially surrounding at least one of the drive rollers, wherein the drive roller chamber is substantially sealed hermetically from the coupling to the drive motor.

23. The method of claim 21, further comprising drawing air from a gear chamber substantially surrounding the coupling to the drive motor, wherein the gear chamber is substantially sealed hermetically from the drive rollers.

24. The method of claim 17, further comprising drawing air from a chamber substantially surrounding at least one of the second and third contacting members.

25. The method of claim 18, wherein an outer surface of at least one of the rollers has a circumferential v-shaped groove formed therein and is substantially comprised of a polyethyletherkeytone (PEEK) material.

26. The method of claim 25, wherein the v-groove comprises a polished groove having surface irregularities no greater than sixty-four micro-inches in depth.

27. The method of claim 18, further comprising:
applying a loading pressure by at least one of the drive rollers perpendicular to the plane of the wafer in the range of one to three pounds.

28. The method of claim 18, wherein rotating further comprises:
rotating the wafer using a speed of rotation of the wafer less than or equal to two revolutions per second.

29. An apparatus for illuminating and imaging a surface of a wafer, said apparatus comprising:
a light source;
a diffuser element to receive light from the light source and transmit a diffused light;
a beam splitter to receive the diffused light and split the diffused light;
a reflective element to receive the split diffused light from the beam splitter and reflect the diffused light onto the surface of the wafer, and to receive a reflected light from the wafer surface; and
a camera to receive and image the reflected light from the wafer,
wherein the reflective element is mounted above or below the wafer and occupies a space of about ¼ inch or less above or below the wafer surface.

30. The apparatus of claim 29,wherein the diffuser element comprises a frosted glass.

31. The apparatus of claim 29, wherein the reflective element comprises a mirror.

32. The apparatus of claim 29, wherein the light source comprises an array of light emitting diodes (LEDs).

33. The apparatus of claim 29, further comprising:
a second reflective element, wherein the first reflective element and second reflective element are mounted on opposite sides of the wafer, and the diffused light is transmitted from the light source to the first and second reflective elements onto the opposite sides of the wafer, wherein the reflected light is received by the camera from both sides of the wafer and comprises an image from both sides of the wafer.

34. The apparatus of claim 33, wherein the reflective elements comprise mirrors, and both the first and second mirrors are mounted within a space of about ¼ inch or less above or below the wafer surface.

35. The apparatus of claim 29, further comprising:
a movable robot arm; and
an end effector attached to an end of the robot arm, said end effector including a gripping mechanism which during operation holds and rotates the wafer about an axis that is perpendicular to the plane of the wafer.

36. The apparatus of claim 33, wherein the gripping mechanism comprises a first contacting member, and a second contacting member, and a drive member arranged to grip opposing edges of the wafer, and
wherein the drive member comprises a first pair of rollers.

37. The apparatus of claim 34, wherein at least one of the first contacting member and the second contacting member comprises a second pair of rollers.

38. The apparatus of claim 35, wherein the gripping mechanism comprises mechanical means coupled to move the drive member towards and away from the second and third contact members in response to a control signal.
